(19) United States
(12) Patent Application Publication
(10) Pub. No.: US 2010/0090567 A1
(43) Pub. Date: Apr. 15, 2010

(54) STORAGE FURNITURE SYSTEM AND METHODS FOR ASSEMBLING THE STORAGE FURNITURE SYSTEM

(75) Inventor: Joseph D. FELICE, Spokane, WA (US)

Correspondence Address: SPECKMAN LAW GROUP PLLC, 1201 THIRD AVENUE, SUITE 330, SEATTLE, WA, 98101, US

(73) Assignee: ERGAMI, LLC, Liberty Lake, WA (US)

(21) Appl. No.: 12/576,888

(22) Filed: Oct. 9, 2009

Related U.S. Application Data
(60) Provisional application No. 61/104,107, filed on Oct. 9, 2008.

(51) Int. Cl. A47B 87/00; F16B 12/00

(52) U.S. Cl. 312/107; 312/111

(57) ABSTRACT

A modular storage furniture system is provided. The furniture system includes at least one cabinet or shelf, at least one interchangeable surface panel, and a support structure. Cabinet side panels are provided with one or more rows of vertically spaced fastening notches that can receive a range of components including, but not limited to, horizontal support rails, cabinet door hinges, cabinet drawer slides, and internal cabinet shelves. The interchangeable surface panels can be removably attached to any side of the cabinet by way of fasteners, connectors, hooks, magnets, or a channel system. The support structure includes at least two vertical fastening posts, with a plurality of notches provided at intervals along the length of each fastening post. A cabinet or shelf can be removably attached to the support structure by inserting hooks provided on the cabinet sides or shelf brackets into the notches. All system components can be dismantled to provide a generally flat and compact shape for easy shipping.

### FIELD OF INVENTION

This invention relates generally to modular furniture systems, and more particularly to storage furniture systems with collapsible and interchangeable components, which can be easily assembled and reconfigured by end users.

### BACKGROUND OF THE INVENTION

Many modular storage systems known in the art generally include a plurality of standardized cabinet and shelf components, such as panels, bases, drawers, brackets, and the like, which are combined and assembled to form a wide variety of storage furniture configurations. Traditionally, these cabinet components are permanently assembled at the factory to create three-dimensional and rigid furniture. In order to package such furniture for handling, storage, and shipment, cartons and other packaging material must be dimensioned to fully enclose the assembled furniture. When such a fully assembled unit of furniture is received at its ultimate destination, it is often too heavy for an end user to safely lift, move, and transport. The end user also has to dispose of a large amount of packaging material for this fully assembled furniture.

The selling price of such pre-assembled furniture not only includes materials and factory assembly costs, but also necessarily takes into account the packaging, handling, and shipping expenses. The volume and weight occupied by this fully assembled furniture is usually substantial. Since shipping charges are generally based on volume as well as weight, the cost to crate and ship this fully assembled furniture can be almost as high as the cost of the raw materials used to construct the furniture.

To overcome the problems related to the handling and shipping of the above-mentioned pre-assembled furniture systems, some furniture systems are supplied to end users boxed and/or shipped in a generally flat and disassembled state, thereby reducing storage, shipping, and handling problems and costs. This “ready-to-assemble” furniture is designed to be assembled by end users at the ultimate destination by way of hardware pieces or connecting and reinforcing elements, such as screws, nuts, bolts, dowels, nails, and the like.

However, much ready-to-assemble furniture is often too difficult for end users with little or no mechanical experience to assemble. In addition, when assembled, this furniture can often lack the strength and stability of conventional furniture assembled with permanently-bonded joints. Furthermore, ready-to-assemble furniture is often shipped with many small hardware pieces, which must be carefully inventoried. Should an end user receive the wrong hardware pieces or an inadequate amount of such pieces, the furniture cannot be properly assembled. Because of the many different types of hardware pieces usually required to assemble such furniture, the hardware pieces can be easily misplaced during the assembly process.

Other factors that should be considered in storage furniture construction and design that should be considered are versatility and flexibility. To accommodate end user's diverse and ever changing preferences, it is desirable for the appearance of storage furniture to be easily changeable. However, the appearance of most traditional storage furniture cannot be easily changed.

U.S. Pat. No. 4,425,597 discloses a furniture system comprising a basic, multi-section structural module that when erected acts to define the vertical side panels of a piece. The erected module is combinable with removable shelves, tops and other horizontal components adapted to bridge the side panels and rigidify the structure. The multi-section module is created by two or more rectangular core panels in side-by-side relation, with fabric layers laminated to the opposing faces that serve to interconnect the sections and define living hinges at the junctions thereof, whereby the sections may be folded over each other in order to collapse the module for purposes of storage or shipment, or folded out to erect the module for purposes of assembly.

U.S. Pat. No. 6,565,166 discloses a molded plastic wall and floor mount cabinets that include integral preformed electrical wire pathways, electrical boxes for mounting power receptacles or switches, junction boxes for housing interconnecting wiring, and lighting component areas. Both the wall and floor mount cabinets include a plastic primary structure that may either be a unitary molded box-like structure or a combination of top, bottom, rear, front, and side members that are then connected together.

U.S. Pat. No. 5,103,741 discloses a freestanding modular furniture arrangement for creating workstations in both open and closed office plans, and other similar applications. Each furniture unit includes a work surface with capped cutouts in the rear corners to mount overhead cabinets, privacy screens, and other furniture accessories. A mounting rail extends continuously along the rearward edge of each work surface, and is capable of removably supporting a plurality of different amenities, such as bookshelves, CRT stands, fans, task lamps, etc., so as to permit a worker to personalize his or her own workstation.

U.S. Pat. No. 6,543,071 discloses furniture pieces designed to span maturity of user from post-crib to adulthood by use of interchangeable panels. The furniture is comprised of a frame with interchangeable panels and backing panel that are connected by means of an attachment system. Interchangeable panels have finishes with themes consistent with various age categories.

U.S. Pat. No. 6,053,585 discloses a cabinet front for a cabinet that includes a generally planar base portion and a frame portion having a recessed portion and a securing portion, wherein the securing portion is fixedly mounted to the base portion. A channel is formed between the frame portion, the securing portion and the base portion. The cabinet front includes a reversible, decorative panel slidably positioned within the channel.

U.S. Pat. No. 7,155,761 discloses an interchangeable furniture system for providing an interchangeable furniture element having faces with different appearances. The desired face may be selected and the interchangeable furniture element selectively oriented to make the selected face visible.

U.S. Pat. No. 5,906,420 discloses an office furniture system of free standing furniture elements which can be linked to each other comprising a modular desk unit and a modular storage unit.

U.S. Pat. No. 3,964,810 discloses a shelf and cabinet system of modular construction, arranged such that, with a few standard components, display shelving, storage cabinets and the like, may be assembled quickly and easily and in a wide variety of configurations. The system includes a preformed structural shelf, which includes aligned sockets and lugs for securing legs and spacer columns. The pre-formed shelving unit includes integral marginal tracks or grooves arranged to receive cabinet panels. U.S. Pat. No. 5,176,435 discloses an interchangeable modular furniture system that is provided with an underlying supporting structure including spaced side walls and a top wall with panels independently and removably mounted to at least one of the walls of the underlying supporting structure. Preferably, independently and removably mounted panels cover at least the spaced side walls and top wall of the underlying supporting structure. Cooperative releasable fasteners are attached to each panel and associated wall for releasable attachment to each other.

### SUMMARY OF THE INVENTION

A collapsible and interchangeable furniture system for creating a wide variety of storage furniture and work spaces is provided. The disclosed furniture system is designed to be light-weight and easy to handle such that it can be readily packaged and transported. The furniture system comprises a small number of components and can be assembled with minimal tools and/or mechanical know-how by end users. In addition, the furniture system can be easily disassembled and reassembled or reconfigured. Further, the furniture system is provided with a plurality of interchangeable components, so that end users may tailor the appearance of the furniture according to the user's taste and preference, and which allow the ornamental and decorative appearance of the furniture to be updated and changed with ease.

The furniture system comprises a plurality of interchangeable cabinets, shelves, surface panels, and support structure components. In one embodiment, the furniture system comprises at least one cabinet or shelf, at least one surface panel, and a support structure.

The cabinets comprise at least two side panels, at least one horizontal top support rail, and a bottom panel. The cabinets may also comprise a back panel, at least one door assembly and/or at least one drawer assembly. Once assembled, these cabinet components form a cabinet which can be attached to the support structure.

In one embodiment, a door assembly comprises a door panel attached to the cabinet shell by connecting hinges provided on the door panel and connected to one of the side panels of the cabinet. In another embodiment, a drawer assembly is provided that comprises a drawer body attached to two drawer slides which are in turn attached to each side panel of the cabinet.

Shelves comprising at least two shelf brackets, a horizontal support rail, and a horizontally mounted surface panel are also provided. Once assembled, these shelf components can be attached to the support structure.

The interchangeable surface panels can be constructed with a variety of colors, materials, and finishes, and can be removably attached to any side of the cabinet shell by way of fasteners, connectors, hooks, magnets, or a channel system. Depending on the attachment method, the surface panels can be reversible. Since the surface panels are removable from the cabinet shell, end users may change the appearance of the furniture system over time.

Depending on the desired furniture configuration, the furniture system's support structure can be freestanding, compressed between the floor and ceiling, or secured to a wall with or without resting on the floor.

The support structure comprises at least two vertical fastening posts. A plurality of notches is provided at intervals along the length of each fastening post. A cabinet or shelf can be attached to the support structure by inserting the hooks provided on the cabinet sides or shelf brackets into the notches. Optionally, one or more horizontal brace assemblies can be attached between fastening posts in order to provide stability to the structure and, when necessary, provide a means of attaching the structure to the wall.

Cabinets and shelves can be removably attached to the support structure. In different embodiments of the furniture system, different post heights, and cabinet and shelf sizes can be configured. In addition to cabinets and shelves, other furniture accessories, such as display racks, desks, tables, benches, and lighting, can be attached to the support structure.

In one specific embodiment, a modular storage furniture system is provided that comprises: (a) a support structure comprising at least two generally vertical fastening posts, each of the fastening posts comprising a plurality of notches spaced apart along a longitudinal axis of the fastening post; (b) a cabinet shell comprising at least two opposing, spaced-part side panels, wherein each of the side panels is provided with a plurality of hooks extending from a back edge of the side panel and at least one row of vertically spaced fastening slots, wherein the cabinet shell is removably attached to the support structure by inserting the plurality of hooks provided on the side panels into the plurality of notches provided on the fastening posts; and (c) at least one interchangeable surface panel that can be removably attached to an outer surface of the cabinet shell. The cabinet shell may be provided with a front panel attached by at least one hinge to one of the at least two side panels.

The furniture system may also include two generally horizontal support rail assemblies that extend between the two side panels, each of the support rail assemblies comprising two fastening hooks, each hook being positioned at an opposing end of the rail assembly and being receivable in one of the vertically spaced fastening slots provided in the side panels; and a generally horizontal upper panel, or top surface, positioned on top of the support rail assemblies. In addition, the furniture system may include a drawer assembly that extends between and is attached to the at least two side panels, the drawer assembly including at least two drawer slides, each of the drawer slides being attached to a side panel by means of fasteners that are retained in one of the vertically spaced fastening slots provided in the side panels.

In another embodiment, a modular storage furniture system disclosed herein comprises: (a) a support structure comprising at least two generally vertical fastening posts, each of the fastening posts comprising a plurality of notches spaced apart along a longitudinal axis of the fastening post; (b) a shelf support structure that comprises: (i) two generally horizontal support rail assemblies; and (ii) at least two generally vertical support brackets, each of the support brackets being attached to one end of each of the two horizontal support rail assemblies, wherein each of the support brackets is provided with a plurality of hooks extending from a back edge of the support bracket, wherein the support brackets are removably attached to the support structure by inserting the plurality of hooks provided on the support brackets into the plurality of notches provided on the fastening posts; (c) a generally horizontal shelf; and (d) at least one interchangeable surface panel that can be removably attached to an upper surface of the shelf.

In certain embodiments, each of the fastening posts comprises an outer extending member and an inner extending member that is slidably received in an inner cavity of the outer extending member, with the plurality of notches being provided along a longitudinal edge of the inner extending member. At least one of the outer extending member and the inner extending member may be provided with a hollow inner channel extending along the length of the member. The support structure may further include at least one generally horizontal brace that extends between the fastening posts.

### BRIEF DESCRIPTION OF THE DRAWINGS

The present invention will be described in greater detail in the following detailed description, with reference to the accompanying drawings, wherein:

FIG. 1 shows a front view of a typical configuration of the disclosed storage furniture system;

FIG. 2 shows a side view of the configuration of FIG. 1;

FIG. 3 shows a side view of a furniture configuration with a wall supported support structure;

FIG. 4 shows a side view of a furniture configuration with a wall hung support structure;

FIG. 5 shows a side view of a furniture configuration with a support structure compressed between the floor and ceiling;

FIG. 6 shows a side view of a furniture configuration with a free standing support structure;

FIG. 7 shows an exploded perspective view of a cabinet and shelf;

FIG. 8 shows a perspective view of an assembled cabinet and shelf without surface panels;

FIG. 9 shows a perspective view of an assembled cabinet and shelf with exploded surface panels;

FIG. 10 shows a perspective view of a completely assembled cabinet and shelf;

FIG. 11 shows an exploded perspective view of a cabinet drawer assembly;

FIG. 12 shows a perspective view of a drawer box and drawer side subassemblies;

FIG. 13 shows a perspective view of an assembled cabinet with drawers without surface panels;

FIG. 14 shows a perspective view of a fully assembled cabinet with drawers;

FIG. 15 shows a perspective view of a cabinet side panel;

FIG. 16 shows an exploded perspective view of a cabinet support rail and cabinet side panel;

FIG. 17 shows a perspective view of a support rail attached to a cabinet side panel;

FIG. 18 shows a partially exploded perspective view of two support rails attaching to two shelf brackets;

FIG. 19 shows a partially exploded perspective view of a support structure fastening post;

FIG. 20 shows a perspective view of the end of an assembled fastening post;

FIG. 21 shows a perspective view of the end of an assembled fastening post with a levelling foot installed;

FIGS. 22A-D show cross-sectional views of the fastening post of FIG. 21 in unassembled and assembled states;

FIG. 23 shows a cross-sectional side view of an embodiment of an assembled fastening system of FIG. 1; and

FIG. 24 shows a perspective view of another embodiment of a fastening post of the support structure.

### DETAILED DESCRIPTION OF THE INVENTION

A collapsible and interchangeable furniture system for creating a wide variety of storage furniture and work spaces is provided. The disclosed furniture system is designed to be light-weight and easy to handle such that it can be readily packaged and transported. The furniture system comprises a small number of components and can be assembled by end users with minimal tools and/or mechanical know-how. In addition, the furniture system can be easily disassembled and reassembled or reconfigured. Further, the furniture system is provided with a plurality of interchangeable components, so that end users may tailor the appearance of the furniture according to the user's taste and preference, and the ornamental and decorative appearance of the furniture can be updated and changed with ease.

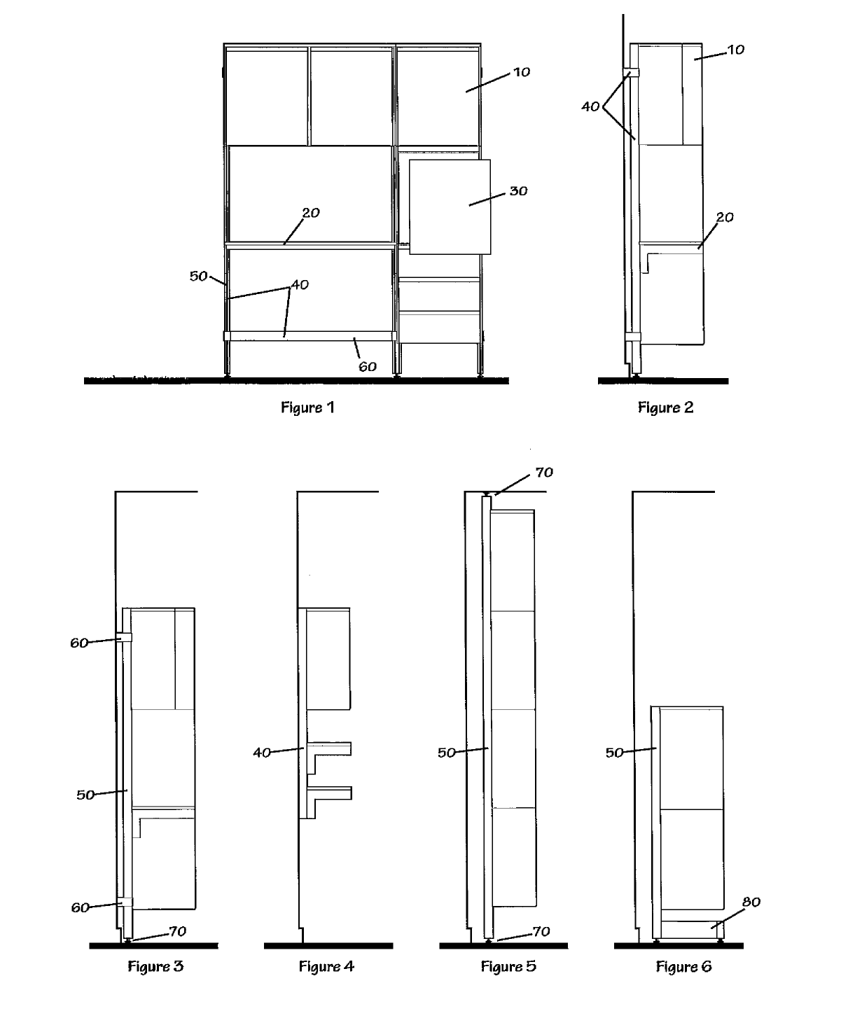

FIG. 1 shows a front view of one furniture configuration constructed from the furniture system disclosed herein. In one embodiment, the furniture system comprises at least one cabinet 10 or shelf 20, at least one interchangeable surface panel 30, and a support structure 40. FIG. 2 shows a side view of the same configuration of the furniture system.

The furniture system's support structure 40 can be constructed in several ways depending on the desired furniture configuration. The support structure comprises at least two vertical fastening posts 50. One or more horizontal brace assemblies 60 can be attached between fastening posts 50 in order to provide stability to the structure and, when necessary, provide a means of attaching the support structure 40 to the wall. FIG. 3 shows an embodiment of support structure 40 in which vertical fastening posts 50 are attached to adjustable leveling feet 70 that rest on the floor while horizontal brace assemblies 60 are attached to a wall. In another embodiment of the support structure shown in FIG. 3, the vertical support structure 40 is attached only to the wall. FIG. 5 illustrates another embodiment in which the vertical fastening posts 50 are compressed between the ceiling and floor with pressure provided by adjustable levelers 70 positioned at both the top and bottom of vertical fastening posts 50. FIG. 4 shows a free standing embodiment in which a rigid base assembly 80 is attached to each vertical fastening post 50.

As shown in FIG. 7, a cabinet 10 comprises two side panels 90, two horizontal support rail assemblies 100 (shown in FIG. 8), and a bottom panel 110. Cabinet 10 may also comprise a back panel 120, at least one door assembly 130 and/or at least one drawer assembly 140. Cabinet 10 can also be provided with inside shelves 150 which are interchangeable with cabinet bottom panels 110. A door assembly 130 comprises a door panel 160, that can be hingeably connected to one of the side panels 90 by way of hinges 170, and hinge mounting hardware 180, as known in the art.

As shown in FIGS. 7-9, shelves 20 comprise two shelf brackets 190, a horizontal support rail assembly 100, and a horizontally mounted surface panel 200. Shelves 20 may also include a surface panel 205 mounted to each shelf bracket 190.

Horizontal support rail assemblies 100 are used for both cabinets and shelves, and comprise a top rail 210 and bottom rail 220 that together create a rigid joint with minimal fasteners as shown in FIGS. 16-18. The front support rail assembly 220 in cabinet 10 has a modified top rail 240 that provides space for the furniture user's fingers when opening a door or drawer. This modified top rail 240 can eliminate the need for cabinet handles and pulls.

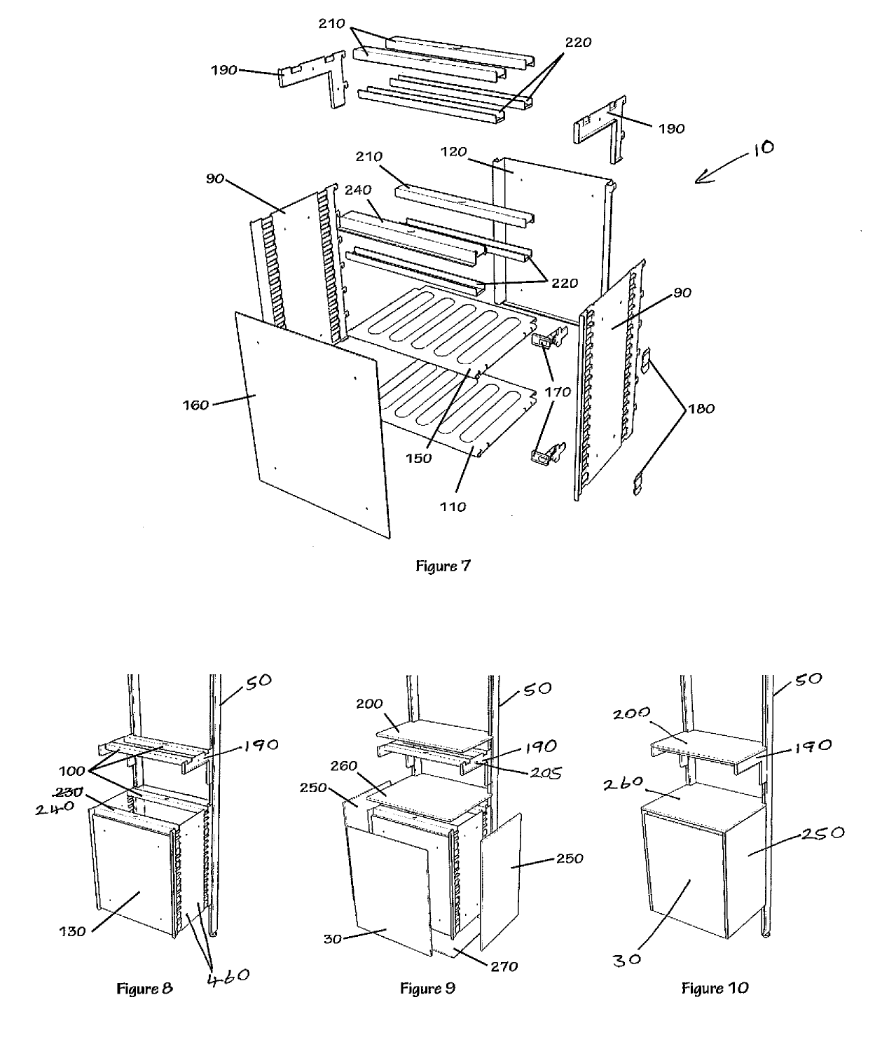

As shown in FIG. 9, at least one surface panel can be removably attached to a surface of the cabinet 10. A cabinet can have surface panels removably attached to all of its sides. A front surface panel 30 is attached to the door assembly 130. Depending on the configuration of the furniture system, side surface panels 250 can be attached to cabinet side panels 90, a top surface panel 260 can be attached to the top support rails 100, a bottom surface panel 270 can be attached to the cabinet bottom panel 110, and a back surface panel (not illustrated) can be attached to the cabinet back panel 120.

In one embodiment, a surface panel is removably attached to a surface of the cabinet or shelf by way of fasteners, such as screws. In other embodiments, the surface panel is removably attached with metal clips or magnets, or by sliding the surface panel into channels provided at the edges of the cabinet panel. The size of the surface panel substantially corresponds to the size of the cabinet or shelf panel to which it is attached. For example, surface panel 250 attachable to the side panel 90 of cabinet 10 is sized substantially equally to the side panel 90. FIG. 10 shows a fully assembled cabinet and shelf including all surface panels.

An assembled cabinet shell 360 comprises two side panels 90, two top rail assemblies 100, and a bottom panel 110. Cabinet shell 360 can accommodate a door assembly 130, a drawer assembly 140 or a combination of the two.

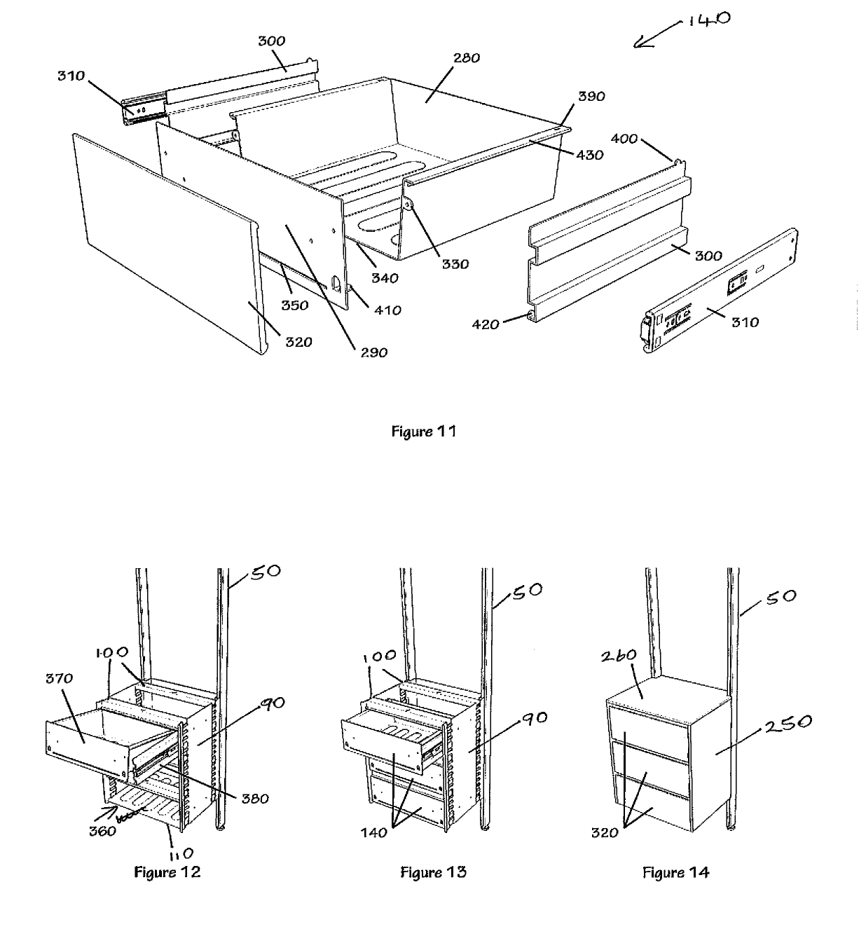

FIG. 11 shows the parts that make up a drawer assembly 140. Drawer assembly 140 comprises a drawer box subassembly 370 and two drawer side subassemblies 380 as shown in FIG. 12. The drawer box subassembly 370 comprises a drawer box 280, and a drawer front panel 290. In one embodiment, drawer box 280 is sized and shaped such that it can be easily nested inside other drawer boxes to reduce the overall dimensions of the drawers for shipping purposes. The drawer front panel 290 can be connected with two fasteners to the drawer box fastening tabs 330. Additional stability for the bottom of the drawer box is provided by sliding drawer bottom tab or front edge 340 into drawer bottom slot 350 provided on the drawer front panel 290. Each drawer side subassembly comprises a drawer side panel 300 and a drawer slide 310. The drawer slide 310 is attached with fastening hardware to both drawer side panel 300, and cabinet side panel 90. FIG. 12 shows the drawer box subassembly 370 being mounted onto drawer side subassemblies 380. This is done by aligning the drawer box slots 390 and 420 with the drawer side tabs 400 and 410, respectively. In doing so, the drawer can be easily mounted and unmounted without the use of fasteners. In FIG. 13, three drawer assemblies 140 are shown in a cabinet shell 360. FIG. 14 shows the same cabinet with surface panels attached, including drawer front surface panels 320.

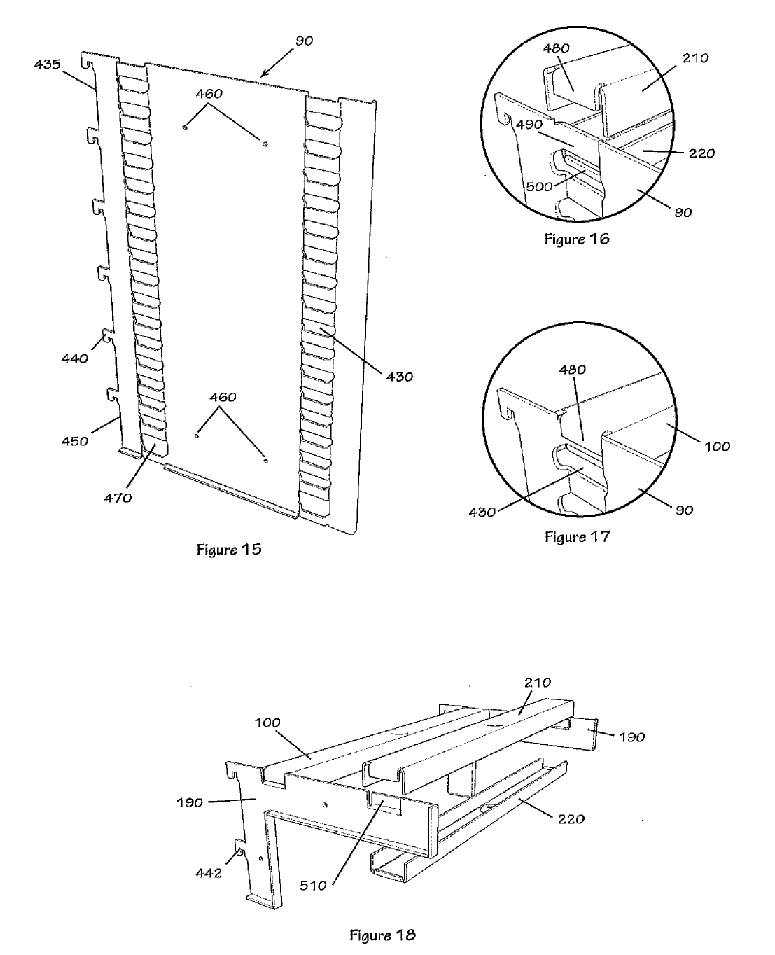

As shown in FIG. 15, side panel 90 of cabinet 10 is provided with a plurality of apertures, or slots, 430 arranged in a vertical column, and a plurality of hooks 440 on the back, or rear, edge 435 of the side panel 90. In one embodiment, both apertures 430 and hooks 440 are spaced apart in substantially equal distance to one another. Hooks 440 extend from rear edge 453 of panel 450 in substantially the same plane as panel 90. Hooks 440 are used to removably attach cabinet 10 to fastening posts 50 of support structure 40. In one embodiment, side panel 90 is also provided with at least one hole 460 for receiving fasteners for surface panels.

The vertical columns of apertures 430 on side panel 90 enable the cabinet to be assembled with a small number of fasteners. FIGS. 16 and 17 show how the horizontal support rail assemblies 100 attach to the apertures 430 on side panels 90. Specially, a fastening tab 480 provided on an end of top rail 210 slides over a bracing tab 490 located above each aperture 430 on side panel 90. The top rail 210 slides over the bottom rail 220 as a locking tab 500 on the bottom rail 220 rests securely against bracing tab 490 on side panel 90. A single fastener (not shown) attaches the top rail 210 to the bottom rail 220 thereby securely locking the horizontal support rail assembly 100 to side panel 90. FIG. 17 shows a horizontal support rail 100 securely attached to a side panel 90. The columns of apertures 430 on side panel 90 are also used to secure removable internal cabinet shelves 150. With the help of hardware mounting plates 180, the apertures 430 are also used to secure door hinges 170 and drawer slides 310.

In addition to enabling secure cabinet assembly as described above, the vertical columns of apertures 430 reduce the overall weight of side panel 90. Further, apertures 430 can be used as ventilation openings for electronic devices. In one embodiment, the bottom aperture 470 in each vertical column is enlarged to allow for extending wires for electronic devices, such as computer peripherals and audio devices, between cabinets.

FIG. 18 shows that horizontal support rail assemblies 100 attach to shelf brackets 190 in a similar fashion to how they attach to cabinet side panels 90, specifically by locking over a bracing tab 510 located on the shelf bracket 190. Shelf brackets 190 also have a plurality of hooks 442 at the back, or rear, edge of the bracket 190. Hooks 442 are used to removably attach the shelf 20 to the fastening posts 50 of the support structure 40.

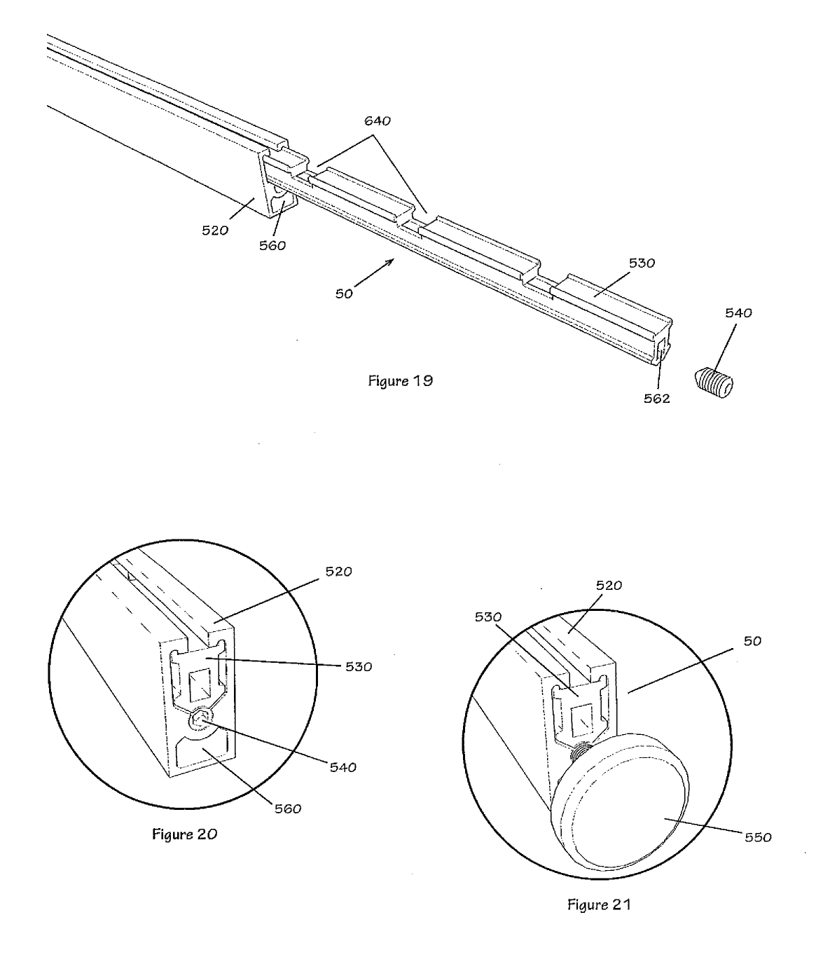

A support structure 40 for supporting assembled cabinets 10 and shelves 20 in different configurations is shown in FIGS. 3 through 6. Support structure 40 includes at least two vertical fastening posts 50. As shown in FIG. 19, a plurality of notches 640 is provided at intervals along the length of each fastening post 50. A cabinet 10 or shelf 20 can be attached to support structure 50 by inserting hooks 440 or 442 provided on the cabinet side panel 90 or shelf bracket 190 into notches 640. Optionally, one or more horizontal brace assemblies 60 can be attached between fastening posts 50 in order to provide stability to the support structure and, when necessary, provide a means of attaching the support structure to a wall.

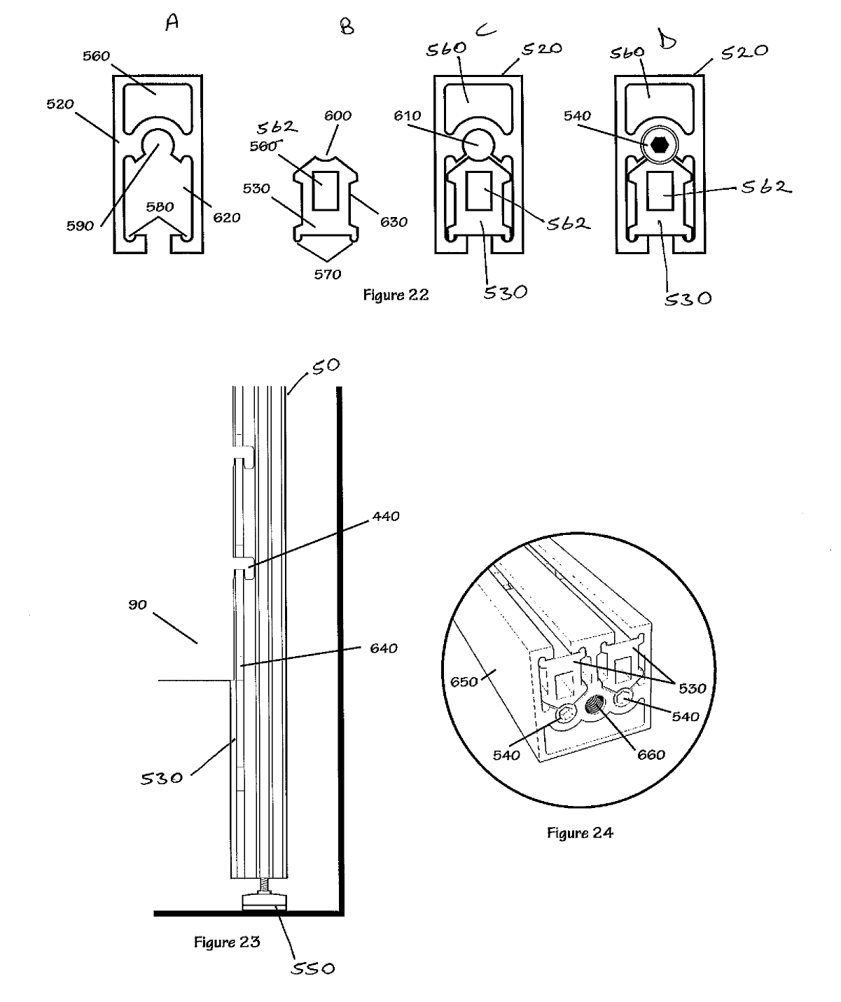

FIGS. 19 through 21 show an embodiment of the fastening post 50 of the support structure 40. The fastening post 50 comprises an outer extending member 510 and an inner extending member 530, with inner extending member being slidably receivable within an inner cavity 620 that runs along the longitudinal axis of outer extending member 520. The extending members 520 and 530 can be locked in place by fasteners, such as set screws 540 and/or leveling feet 550, at one or both ends of the inner and outer extending members 520 and 530. As shown in FIG. 22, outer and inner extending members 520 and 530 are provided with hollow channels 560 and 562 extending substantially along the length of the extending members 520 and 530 to reduce the member weight. The hollow channels 560 shown in FIG. 22 have irregular configurations, but it will be appreciated that other configurations can be used for the hollow channels. Two anchoring protrusions 570 are provided on the inner extending member 530 that correspond to the anchoring channels 580 of the outer extending member 520. A first curved channel 590 is provided along one side of inner cavity 620 of outer extending member 520 and extends along the longitudinal axis of member 520. Channel 590 corresponds to a second curved channel 600 that is provided along an outer edge of the inner extending member 530 and extends along the longitudinal axis of member 530. The interior profile of cavity 620 of the outer extending member 520 corresponds to the exterior profile 630 of the inner extending member 530 such that the inner extending member 530 can be slidably fitted through cavity 620 of the outer extending member 520. When the outer and inner extending members 520 and 530 are assembled, the first and second curved channels 590 and 600 form a substantially cylindrical channel 610 extending along the length of the assembled outer and inner extending members 520 and 530. A fastener 540, such as a set screw, can be inserted into the receiving end of cylindrical channel 610 to lock the outer and inner extending members 520 and 530 in place. A leveler 550 can optionally be connected to the outer end of the cylindrical channel 610.

A plurality of notches 640 is provided along the inner extending member 530. In this embodiment, the notches 640 are substantially rectangular and positioned substantially equal distance from one another. As shown in FIG. 23, the cabinet 10 can be removably attached to the fastening post 50 by inserting the hooks 440 provided on the cabinet side panels 90 into the exposed notches 640 of the inner extending member 530. Shelves can be removably attached to the fastening post 50 in the same manner by inserting hooks 440 provided on shelf bracket 190 into the exposed notches 640 of the inner extending member 530.

FIG. 24 shows another embodiment of the fastening post, having two inner extending members 530 and one wider outer extending member 650. When assembled, the fastening post is provided with two sets of notches 640 along the length of the inner extending members 530 and three cylindrical channels, two formed by the outer and inner extending members 650 and 530, and another 660 formed only by the wider outer extending member 650. This third cylindrical channel 660 is intended to accept a leveling foot 550. This embodiment of the fastening post 50 is useful to provide additional weight support and stability when the furniture system includes side by side columns of cabinet shells 10 and shelves 20.

While certain embodiments of the present invention have been described, it will be understood that various changes could be made in the above constructions without departing from the scope of the invention. It is intended that all matter contained in the above description or shown in the accompanying drawings shall be interpreted as illustrative and not in a limiting sense.

I claim:

1. A modular storage furniture system, comprising:
(a) a support structure comprising at least two generally vertical fastening posts, each of the fastening posts comprising a plurality of notches spaced apart along a longitudinal axis of the fastening post;
(b) a cabinet shell comprising at least two opposing, spaced-part side panels, wherein each of the side panels is provided with a plurality of hooks extending from a back edge of the side panel and at least one row of vertically spaced fastening slots, wherein the cabinet shell is removably attached to the support structure by inserting the plurality of hooks provided on the side panels into the plurality of notches provided on the fastening posts; and
(c) at least one interchangeable surface panel that can be removably attached to an outer surface of the cabinet shell.

2. The modular storage furniture system of claim 1, further comprising a front panel attached by at least one hinge to one of the at least two side panels.

3. The modular storage furniture system of claim 1, wherein the interchangeable surface panel is attached to the outer surface of the cabinet shell by means of fasteners, connectors, hooks, magnets, or a channel system.

4. The modular storage furniture system of claim 1, wherein each of the fastening posts comprises an outer extending member and an inner extending member that is slidably received in an inner cavity of the outer extending member, wherein the plurality of notches are provided along a longitudinal edge of the inner extending member.

5. The modular storage furniture system of claim 4, wherein at least one of the outer extending member and the inner extending member comprises a hollow channel extending along the length of the member.

6. The modular storage furniture system of claim 4, wherein the outer extending member and the inner extending member are locked in place by means of a fastener at each end of the fastening post.

7. The modular storage furniture system of claim 1, wherein the support structure further comprises at least one generally horizontal brace that extends between the fastening posts.

8. The modular storage furniture system of claim 1, further comprising at least one generally horizontal shelf that is attached to each of the two side panels by means of hooks provided along an edge of the shelf, each of the hooks being received in one of the vertically spaced fastening slots.

9. The modular storage furniture system of claim 1, further comprising:
(a) two generally horizontal support rail assemblies that extend between the two side panels, each of the support rail assemblies comprising two fastening hooks, each hook being positioned at an opposing end of the rail assembly and being receivable in one of the vertically spaced fastening slots provided in the side panels; and
(b) a generally horizontal upper panel positioned on top of the support rail assemblies.

10. The modular storage furniture system of claim 1, further comprising a drawer assembly that extends between and is attached to the at least two side panels, the drawer assembly including at least two drawer slides, each of the drawer slides being attached to a side panel by means of fasteners that are retained in one of the vertically spaced fastening slots provided in the side panels.

11. A modular storage furniture system, comprising:
(a) a support structure comprising at least two generally vertical fastening posts, each of the fastening posts comprising a plurality of notches spaced apart along a longitudinal axis of the fastening post;
(b) a shelf support structure comprising:
(i) two generally horizontal support rail assemblies; and
(ii) at least two generally vertical support brackets, each of the support brackets being attached to one end of each of the two horizontal support rail assemblies, wherein each of the support brackets is provided with a plurality of hooks extending from a back edge of the support bracket, wherein the support brackets are removably attached to the support structure by inserting the plurality of hooks provided on the support brackets into the plurality of notches provided on the fastening posts;
(c) a generally horizontal shelf; and
(d) at least one interchangeable surface panel that can be removably attached to an upper surface of the shelf.

12. The modular storage furniture system of claim 11, wherein the interchangeable surface panel is attached to the upper surface of the shelf by means of fasteners, connectors, hooks, magnets, or a channel system.

13. The modular storage furniture system of claim 11, wherein the support structure further comprises at least one generally horizontal brace that extends between the fastening posts.

14. The modular storage furniture system of claim 11, wherein each of the fastening posts comprises an outer extending member and an inner extending member that is slidably received in an inner cavity of the outer extending member, wherein the plurality of notches are provided along a longitudinal edge of the inner extending member.

15. The modular storage furniture system of claim 14, wherein at least one of the outer extending member and the inner extending member comprises a hollow channel extending along the length of the member.

16. The modular storage furniture system of claim 14, wherein the outer extending member and the inner extending member are locked in place by means of a fastener at each end of the fastening post.
